(19) United States
(12) Patent Application Publication
(10) Pub. No.: US 2010/0019673 A1
(43) Pub. Date: Jan. 28, 2010

(54) PLASMA DISPLAY PANEL

(76) Inventor: Sungyong Ahn, Gyoungsangbuk-do (KR)

Correspondence Address: KED & ASSOCIATES, LLP, P.O. Box 221200, Chantilly, VA, 20153-1200, US

(21) Appl. No.: 12/518,750

(22) PCT Filed: Dec. 11, 2007
(86) PCT No.: PCT/KR2007/006440

§ 371 Date: Jun. 11, 2009

(30) Foreign Application Priority Data
Dec. 14, 2006 (KR) 10-2006-0127682

(51) Int. Cl. H01J 17/49

(52) U.S. Cl. 313/585

(57) ABSTRACT

A plasma display panel is provided. The plasma display panel comprises: a front substrate; a rear substrate opposite to the front substrate; a discharge cell formed between the front substrate and the rear substrate; a first electrode and a second electrode opposite to each other in the discharge cell; a third electrode intersecting the first electrode and the second electrode in the discharge cell; a first alignment mark formed in the rear substrate; and a lower dielectric layer for covering the third electrode and the first alignment mark, wherein the lower dielectric layer comprises CuO, and a thickness of the lower dielectric layer is 5 μm to 12 μm.

### TECHNICAL FIELD

This document relates to a plasma display panel.

### BACKGROUND ART

In general, in a plasma display panel, a phosphor layer and a plurality of electrodes are disposed within a discharge cell partitioned with barrier ribs. A driving signal is supplied to the electrodes.

Within the discharge cell, a discharge is generated by the supplied driving signal. When a discharge is generated by the driving signal within the discharge cell, a discharge gas filled within the discharge cell generates vacuum ultraviolet rays, the vacuum ultraviolet rays enable a phosphor disposed within the discharge cell to emit light, thereby generating visible light. By the visible light, an image is displayed on a screen of a plasma display panel.

In the plasma display panel, after a front substrate and a rear substrate are separately manufactured, the front substrate and the rear substrate are cohered. In order to help cohesion of the front substrate and the rear substrate, alignment marks are formed in each of the front substrate and the rear substrate.

### DISCLOSURE

### Technical Problem

Because an alignment mark is covered with a dielectric layer, when two substrates are cohered, the alignment mark is not seen.

An aspect of this document is to provide a plasma display panel that can improve a withstand voltage characteristic of a lower dielectric layer and facilitate a cohesion process of a front substrate and a rear substrate by enabling an alignment mark to be easily seen.

### Technical Solution

In one general aspect, a plasma display panel comprises: a front substrate; a rear substrate opposite to the front substrate; a discharge cell formed between the front substrate and the rear substrate; a first electrode and a second electrode opposite to each other in the discharge cell; a third electrode intersecting the first electrode and the second electrode in the discharge cell; a first alignment mark formed in the rear substrate; and a lower dielectric layer for covering the third electrode and the first alignment mark, wherein the lower dielectric layer comprises CuO, and a thickness of the lower dielectric layer is 5 μm to 12 μm.

The lower dielectric layer may comprise at least two materials selected from PbO, SiO2, B2O3, Al2O3, and TiO2.

A portion in which the first alignment mark is formed has a thickness smaller than that of other portions in the lower dielectric layer.

The third electrode and the first alignment mark may be made of the same material.

A second alignment mark corresponding to the first alignment mark may be formed in the front substrate.

In another aspect, a plasma display panel comprises: a front substrate; a rear substrate opposite to the front substrate; a discharge cell formed between the front substrate and the rear substrate; a first electrode and a second electrode opposite to each other in the discharge cell; a third electrode intersecting the first electrode and the second electrode in the discharge cell; a first alignment mark formed in the rear substrate; and a lower dielectric layer for covering the third electrode and the first alignment mark, wherein the lower dielectric layer comprises CuO of 0.1 wt % to 0.5 wt %.

In another aspect, a plasma display panel comprises: a front substrate; a rear substrate opposite to the front substrate; a discharge cell formed between the front substrate and the rear substrate; a first electrode and a second electrode opposite to each other in the discharge cell; a third electrode intersecting the first electrode and the second electrode in the discharge cell; a first alignment mark formed in the rear substrate; and a lower dielectric layer for covering the third electrode and the first alignment mark, wherein a thickness of the lower dielectric layer is 5 μm to 12 μm, and the lower dielectric layer comprises CuO of 0.1 wt % to 0.5 wt %.

### ADVANTAGEOUS EFFECTS

In a plasma display panel in an implementation of this document, because a lower dielectric layer comprises a CuO material, a withstand voltage characteristic of the lower dielectric layer can be improved.

Further, when the lower dielectric layer comprises CuO, an alignment mark covered with the lower dielectric layer can be seen well by forming a thickness of the lower dielectric layer in 5 μm to 12 μm.

Further, an alignment mark covered with the lower dielectric layer can be seen well by increasing transparency of the lower dielectric layer through adjusting well a composition ratio of CuO comprised in the lower dielectric layer.

### DESCRIPTION OF DRAWINGS

FIG. 1 is a perspective view illustrating a structure of a plasma display panel in an implementation of this document;

FIG. 2 is an exploded perspective view of a plasma display panel illustrating an alignment mark;

FIG. 3 is an enlarged plan view illustrating an aligned state of the first and second alignment marks;

FIG. 4 is a cross-sectional view illustrating a dielectric layer formed on the rear substrate;

FIG. 5 is a table showing whether a bubble is generated according to a CuO content of a lower dielectric layer;

FIG. 6 is a table showing whether a color is changed according to a CuO content of a lower dielectric layer;

FIG. 7 is a table showing whether insulation is broken down according to a thickness of a lower dielectric layer;

FIG. 8 is a table showing the change of transparency according to a thickness of a lower dielectric layer;

FIG. 9 is a perspective view illustrating a shape in which a lower dielectric layer is partially removed in a portion of the lower dielectric layer in which an alignment mark is formed;

FIG. 10 is a cross-sectional view illustrating a shape in which a portion in which an alignment mark is formed has a thickness smaller than that of other portions in a lower dielectric layer; and

FIG. 11 is a plan view illustrating a shape of a first electrode and a second electrode of a plasma display panel in another implementation of this document.

### BEST MODE

Hereinafter, a plasma display panel in an implementation of this document is described in detail with reference to the attached drawings.

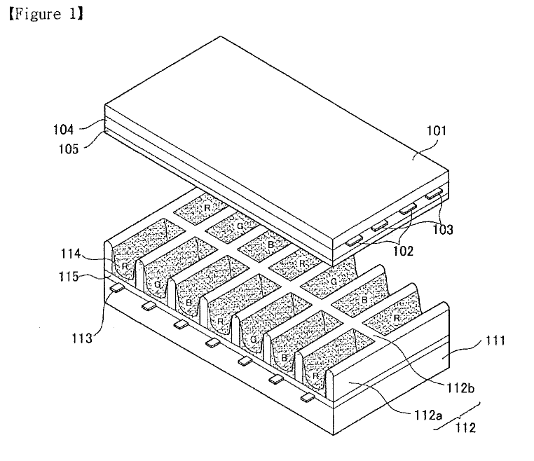

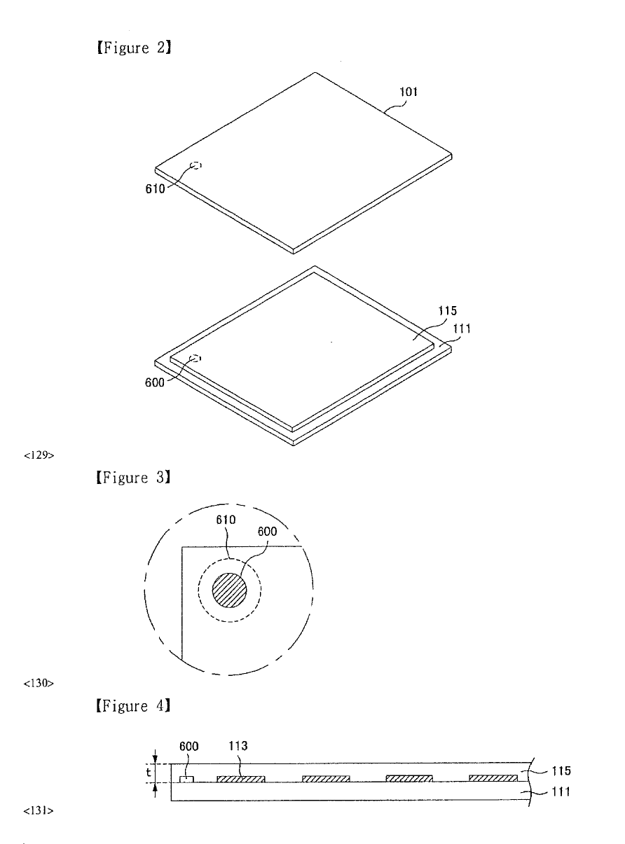

FIG. 1 is a perspective view illustrating a structure of a plasma display panel in an implementation of this document. FIG. 2 is an exploded perspective view of a plasma display panel illustrating an alignment mark. FIG. 3 is an enlarged plan view of an alignment mark in a state in which a front substrate and a rear substrate are cohered.

Referring to FIGS. 1 to 3, the plasma display panel is formed by cohering a front substrate 101 in which a first electrode 102 (Y) and a second electrode 103 (Z) in parallel to each other are disposed and a rear substrate 111 in which a third electrode 113 (X) intersecting the first electrode 102 (Y) and the second electrode 103 (Z) is disposed and that is opposite to the front substrate 101.

A dielectric layer, for example an upper dielectric layer 104 for covering the first electrode 102 (Y) and the second electrode 103 (Z) can be disposed in an upper part of the front substrate 101 in which the first electrode 102 (Y) and the second electrode 103 (Z) are disposed.

The upper dielectric layer 104 limits a discharge current of the first electrode 102 (Y) and the second electrode 103 (Z) and insulates the first electrode 102 (Y) and the second electrode 103 (Z) from each other.

Further, a protective layer 105 can be disposed on the upper dielectric layer 104. The protective layer 105 may be made of a material having a high secondary electron emission coefficient, for example a magnesium oxide (MgO) material.

An electrode, for example a third electrode 113 (X) is disposed in the rear substrate 111, and a first alignment mark 600 is formed in a corner portion. The first alignment mark 600 can be formed with the same process as the third electrode, and thus the first alignment mark 600 may be made of the same material as Ag, as in the third electrode 115. A second alignment mark 610 is formed in the front substrate 101 opposite to the first alignment mark 600. As shown in FIG. 3, the first alignment mark 600 is a solid circle and the second alignment mark 610 is a hollow circle, and when the first alignment mark 600 enters the circle of the second alignment mark 610, the front substrate 101 and the rear substrate 111 are aligned.

As shown in FIG. 2, in an upper part of the rear substrate 111 in which the third electrode 113 (X) is disposed, a dielectric layer, for example a lower dielectric layer 115 for covering the third electrode 113 (X) and the first alignment mark 600 is formed.

In an upper part of the lower dielectric layer 115, a barrier rib 112, having various forms such as a stripe type, a well type, a delta type, and a hive type, for partitioning a discharge space, i.e. a discharge cell can be formed.

According to a phosphor 114 formed in the discharge cell, as a discharge cell, a red color (R) discharge cell, a green color (G) discharge cell, and a blue color (B) discharge cell are formed.

The first electrode 102 (Y) and the second electrode 103 (Z) are formed in parallel to each other with a discharge cell interposed therebetween and intersect the third electrode 115. Accordingly, discharge cells to be turned on by an addressing discharge of the first electrode 102 and the third electrode 115 are selected, and in the following sustain period, a discharge can be selectively generated in only discharge cells selected by applying a sustain pulse to the first electrode 102 and the second electrode 103.

A width of at least one of the red color (R) discharge cell, the green color (G) discharge cell, and the blue color (B) discharge cell in the plasma display panel in an implementation of this document may be formed differently from widths of other discharge cells.

For example, a width of the red color (R) discharge cell may be smallest, and widths of the green color (G) discharge cell and the blue color (B) discharge cell may be greater than a width of the red color (R) discharge cell.

A width of the green color (G) discharge cell may be substantially equal to or different from that of the blue color (B) discharge cell.

A color temperature characteristic of an embodied image can be improved.

A discharge gas is filled within the discharge cell partitioned by the barrier rib 112.

A phosphor layer 114 for emitting visible light can be disposed within the discharge cell partitioned by the barrier rib 112. The phosphor layer 114 can be divided into a red color (R) phosphor layer, a green color (G) phosphor layer, and a blue color (B) phosphor layer according to a light emitting color, and can be formed at each of one column of discharge cells disposed along the third electrode 113.

Further, a thickness of the phosphor layer 114 in at least one of the red color (R) discharge cell, the green color (G) discharge cell, and the blue color (B) discharge cell may be different from thicknesses of the phosphor layer 114 in the other discharge cells. For example, a thickness of the blue color (B) phosphor layer may be thicker than that of a phosphor layer in the red color (R) discharge cell, i.e. the red color (R) phosphor layer. Here, a thickness of the green color (G) phosphor layer may be substantially equal to or different from that of the blue color (B) phosphor layer.

In the above-described description, an example of the plasma display panel in the implementation of this document is described, and this document is not limited to the plasma display panel having the above-described structure.

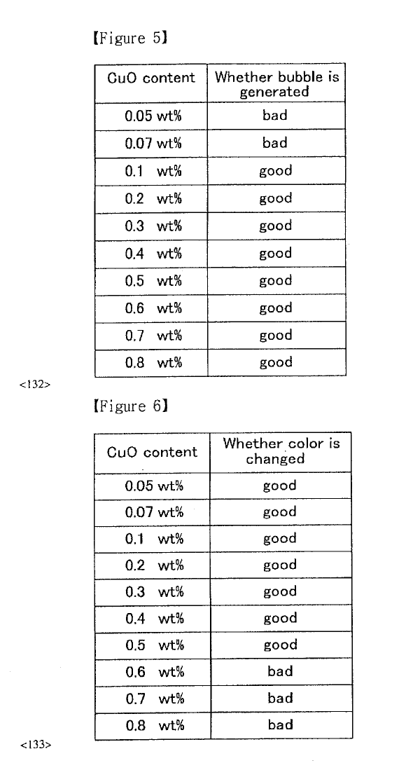

FIG. 4 is a cross-sectional view illustrating in detail a lower dielectric layer, and the lower dielectric layer is described in detail.

Referring to FIG. 4, the lower dielectric layer 115 formed in the rear substrate 111 is disposed to cover the third electrode 113 in order to prevent insulation breakdown of the third electrode 113. Further, the lower dielectric layer 115 covers the first alignment mark 600.

The lower dielectric layer 115 forms lower dielectric paste by mixing a lower dielectric material with other materials such as an organic solvent, coats the formed lower dielectric paste on the rear substrate 111 in which the third electrode 113 and the first alignment mark 600 are formed, and by drying and firing the coated lower dielectric paste, the lower dielectric layer 115 can be formed.

It is preferable to form a thickness (t) of the lower dielectric layer 115 in about 5 μm to 12 μm.

The lower dielectric layer 115 comprises CuO. When firing the lower dielectric paste coated on the rear substrate 111 in which the third electrode 113 is formed, the CuO performs a function of lowering viscosity of the lower dielectric paste.

Accordingly, when fired, an operation for discharging a bubble generating within the lower dielectric paste to the outside, i.e. a bubble removing operation can be promoted. Accordingly, after the lower dielectric layer 115 is finally formed, a bubble does not remain within the lower dielectric layer 115. Therefore, a withstand voltage characteristic of the lower dielectric layer 115 is improved.

When a CuO content is few, a bubble removing operation is not smoothly performed, whereby a bubble remains within the lower dielectric layer 115 and thus a withstand voltage characteristic of the lower dielectric layer 115 is deteriorated. Further, in a case where a CuO content excessively exists, when the lower dielectric paste is fired, a part of CuO is changed to Cu3O3,and thus a reaction group of the lower dielectric paste increases. Accordingly, because undesirable additional reactions are generated, a characteristic of the lower dielectric layer 115 is deteriorated, for example a color of the lower dielectric layer 115 is changed.

FIGS. 5 to 8 are tables illustrating in detail a characteristic of the lower dielectric layer.

First, FIG. 5 shows observed data on whether a bubble is generated according to a content of a CuO material of the lower dielectric layer. FIG. 5 shows that the lower dielectric layer comprises at least two materials selected from PbO, SiO2, B2O3, Al2O3, and TiO2 and CuO and whether a bubble is generated while changing a CuO content from 0.05 wt % to 0.8 wt %.

As shown in FIG. 5, when the lower dielectric layer comprises CuO of less than 0.1 wt %, a bubble is generated within the lower dielectric layer, and thus a withstanding voltage characteristic of the lower dielectric layer can be deteriorated.

When the lower dielectric layer comprises CuO of more than 0.1 wt %, because a bubble is not generated within the lower dielectric layer, a withstand voltage characteristic of the lower dielectric layer can be stabilized.

FIG. 6 shows observed data on whether a color is changed according to a content of a CuO material of the lower dielectric layer. As in FIG. 5, FIG. 6 shows that the lower dielectric layer comprises at least two materials selected from PbO, SiO2, B2O3, Al2O3, and TiO2 and CuO and observed data on whether a color is changed while changing a CuO content from 0.05 wt % to 0.8 wt %.

As shown in FIG. 6, when the lower dielectric layer comprises a CuO material of more than 0.5 wt %, because an undesirable reaction is generated, a color of the lower dielectric layer is changed.

When the lower dielectric layer comprises a CuO material of 0.5 wt % or less, generation of an undesirable reaction is suppressed, whereby a color of the lower dielectric layer becomes good.

In consideration of results of FIGS. 5 and 6, it is advantageous that the lower dielectric layer comprises a CuO material of about 0.1 wt % to 0.5 wt %.

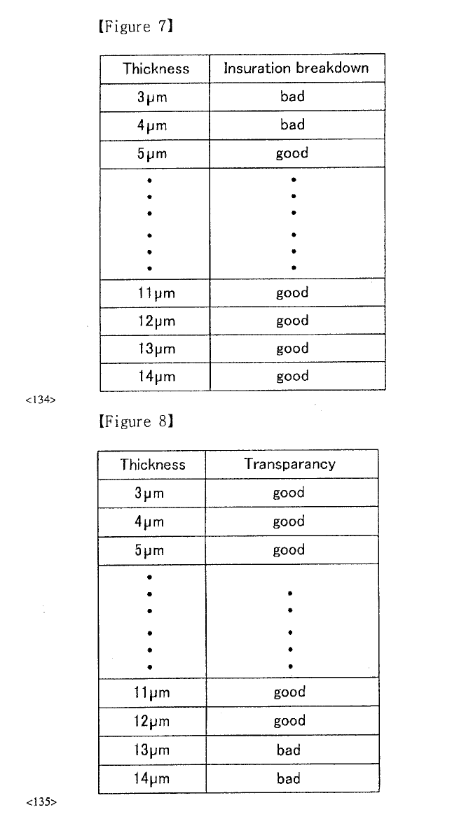

FIG. 7 shows observed data on whether insulation is broken down according to a thickness of the lower dielectric layer. FIG. 7 shows that the lower dielectric layer comprises at least two materials selected from PbO, SiO2, B2O3, Al2O3, and TiO2 and a CuO material and whether insulation of the third electrode is broken down while changing a thickness of the lower dielectric layer from about 3 μm to 14 μm.

As shown in FIG. 7, when a thickness of the lower dielectric layer is less than 5 μm, an insulation breakdown phenomenon of the third electrode may be generated. When a thickness of the lower dielectric layer is more than 5 μm, the lower dielectric layer can fully prevent insulation breakdown of the third electrode.

FIG. 8 shows observed data of transparency according to a thickness of the lower dielectric layer. FIG. 8 shows that the lower dielectric layer comprises at least two materials selected from PbO, SiO2, B2O3, Al2O3, and TiO2 and a CuO material and the change of transparency of the lower dielectric layer while changing a thickness of the lower dielectric layer from about 3 μm to 14 μm.

As shown in FIG. 8, when a thickness of the lower dielectric layer exceeds 12 μm, transparency of the lower dielectric layer may be bad. Accordingly, it is difficult to observe the first alignment mark 600 covered with the lower dielectric layer 115. When a thickness of the lower dielectric layer is 12 μm or less, the lower dielectric layer can fully secure transparency.

Whether good or bad of transparency according to a thickness of the lower dielectric layer can be determined by observing the first alignment mark 600 covered with the lower dielectric layer.

In consideration of results of FIGS. 7 and 8, it is advantageous that a thickness of the lower dielectric layer is about 5 μm to 12 μm.

Unlike an implementation of this document, when the lower dielectric layer does not comprise a CuO material, a material, for example a silver (Ag) material of the third electrode disposed at the rear substrate can be diffused to the lower dielectric layer. Accordingly, a color of a part of the lower dielectric layer can be changed. This is called a migration phenomenon.

In a case where the lower dielectric layer does not comprise CuO, when the front substrate and the rear substrate are cohered, a portion in which a color is changed can be used as a reference. That is, using a portion in which a color of the lower dielectric layer is changed as an alignment mark, the front substrate and the rear substrate are cohered.

However, as in an implementation of this document, when the lower dielectric layer 115 comprises CuO, because a migration phenomenon is prevented, when the front substrate 101 and the rear substrate 111 are cohered, a discolored portion to be a reference does not exist in the lower dielectric layer 115. Therefore, when the front substrate 111 and the rear substrate 115 are cohered, the first alignment mark 600 to be a reference is provided in the rear substrate 111 and a second alignment mark 610 corresponding to the first alignment mark 600 is provided in the front substrate 101.

As described in detail in FIG. 8, when a thickness of the lower dielectric layer 115 is 5 μm to 12 μm, because transparency thereof is fully secured, when the front substrate 101 and the rear substrate 111 are cohered, the first alignment mark 600 provided under the lower dielectric layer 115 can be fully clearly seen.

Accordingly, when a cohesion process is performed, the front substrate 101 and the rear substrate 111 can be easily cohered by using the fully clearly seen first alignment mark 600 and second alignment mark 610 as a reference, as in FIG. 3.

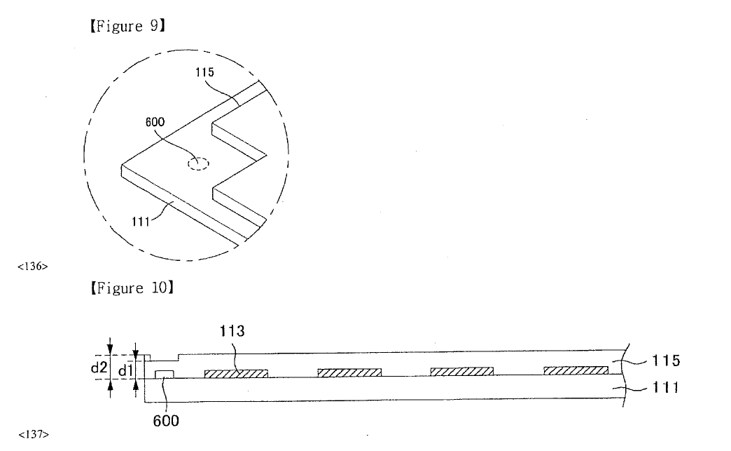

FIG. 9 is a view illustrating another structure of a lower dielectric layer.

Referring to FIG. 9, the lower dielectric layer 115 is omitted around the first alignment mark 600 disposed at the rear substrate 111.

For example, as a method of etching and removing a part of the lower dielectric layer 115 around the first alignment mark 600, the lower dielectric layer 115 around the first alignment mark 600 may be omitted.

In another implementation of this document, by omitting the lower dielectric layer 115 around the first alignment mark 600, the first alignment mark 600 can be seen well than when the first alignment mark 600 is covered with the lower dielectric layer 115.

Further, in another implementation, as in FIG. 10, a thickness (d1) of the lower dielectric layer 115 for covering the first alignment mark 600 may be formed to be smaller than a thickness (d2) of other portions. In this way, because a thickness of the lower dielectric layer 115 corresponding to the first alignment mark 600 is thinner than that of other portions, the first alignment mark 600 can be seen well through the lower dielectric layer 115.

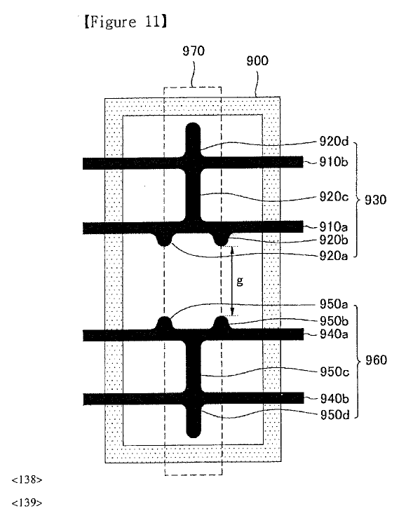

FIG. 11 is a plan view illustrating a first electrode and a second electrode of a plasma display panel in another implementation of this document.

When compared with the above-described implementation, because the implementation shown in FIG. 10 has the difference in only a configuration of the first electrode and the second electrode, a detailed description of other portions is omitted. FIG. 11 selectively shows arrangement of the first electrode and the second electrode for one discharge cell.

In FIG. 11, at least one of a first electrode 930 and a second electrode 960 comprises line portions (910a, 910b, 940a, and 940b) and protruded portions (920a, 920b, 920d, 950a, 950b, and 950d) protruded from the line portions (910a, 910b, 940a, and 940b). Further, at least one of the first electrode 930 and the second electrode 960 may comprise one layer, which is a bus electrode.

As an example, the first electrode 930 comprises the first line portion 910a opposite to the second electrode 960 in a central part of a discharge cell and the second line portion 910b in parallel to and apart a predetermined distance from the first line portion 910a. Further, the first line portion 910a and the second line portion 910b are connected by a connection portion 920c.

The first line portion 910a comprises a pair of protruded portions (920a, 920b), and because the protruded portions (920a, 920b, 950a, and 950b) of the first electrode 930 and the second electrode 960 are opposite to each other with a discharge gap therebetween, an interval (g) between the first electrode 930 and the second electrode 960 is narrower than a portion in which the protruded portions (920a, 920b, 950a, and 950b) do not exist, and thus a discharge firing voltage between the first electrode 930 and the second electrode 960 can be lowered.

In a plasma display panel in another implementation of this document, because electrodes thereof consist of only line portions (910a, 910b, 940a, and 940b) of a bus electrode without a transparent electrode, an aperture ratio of a discharge can become greater than a conventional combination of a transparent electrode and a bus electrode.

An ITO-less electrode structure that does not use a transparent electrode is advantageous in increasing an aperture ratio as described above, however has a problem that brightness is deteriorated. However, if the protruded portions (920a, 920b, 950a, and 950b) is misaligned i.e. if the protruded portions (920a, 920b, 950a, and 950b) are not positioned at a central portion of a discharge cell partitioned by a barrier rib, brightness may be more deteriorated. However, in this document, by using the above-described alignment mark, misalignment of the front substrate and the rear substrate can be previously prevented, whereby a problem that may be generated in the ITO-less electrode structure can be previously prevented.

1. A plasma display panel comprising:
a front substrate;
a rear substrate opposite to the front substrate;
a discharge cell formed between the front substrate and the rear substrate;
a first electrode and a second electrode opposite to each other in the discharge cell;
a third electrode intersecting the first electrode and the second electrode in the discharge cell;
a first alignment mark formed in the rear substrate; and
a lower dielectric layer for covering the third electrode and the first alignment mark,
wherein the lower dielectric layer comprises CuO, and a thickness of the lower dielectric layer is 5 μm to 12 μm.

2. The plasma display panel of claim 1, wherein the lower dielectric layer comprises at least two materials selected from PbO, SiO2, B2O3, Al2O3, and TiO2.

3. The plasma display panel of claim 1, wherein a portion in which the first alignment mark is formed has a thickness smaller than that of other portions in the lower dielectric layer.

4. The plasma display panel of claim 1, wherein the third electrode and the first alignment mark are made of the same material.

5. The plasma display panel of claim 1, wherein a second alignment mark corresponding to the first alignment mark is formed in the front substrate.

6. A plasma display panel comprising:
a front substrate;
a rear substrate opposite to the front substrate;
a discharge cell formed between the front substrate and the rear substrate;
a first electrode and a second electrode opposite to each other in the discharge cell;
a third electrode intersecting the first electrode and the second electrode in the discharge cell;
a first alignment mark formed in the rear substrate; and
a lower dielectric layer for covering the third electrode and the first alignment mark,
wherein the lower dielectric layer comprises CuO of 0.1 wt % to 0.5 wt %.

7. The plasma display panel of claim 6, wherein the lower dielectric layer comprises at least two materials selected from PbO, SiO2, B2O3, Al2O3, and TiO2.

8. The plasma display panel of claim 6, wherein a portion in which the first alignment mark is formed has a thickness smaller than that of other portions in the lower dielectric layer.

9. The plasma display panel of claim 6, wherein the third electrode and the first alignment mark are made of the same material.

10. The plasma display panel of claim 6, wherein a second alignment mark corresponding to the first alignment mark is formed in the front substrate.

11. A plasma display panel comprising:
a front substrate;
a rear substrate opposite to the front substrate;
a discharge cell formed between the front substrate and the rear substrate;
a first electrode and a second electrode opposite to each other in the discharge cell;
a third electrode intersecting the first electrode and the second electrode in the discharge cell;
a first alignment mark formed in the rear substrate; and
a lower dielectric layer for covering the third electrode and the first alignment mark,
wherein a thickness of the lower dielectric layer is 5 μm to 12 μm, and the lower dielectric layer comprises CuO of 0.1 wt % to 0.5 wt %.

12. The plasma display panel of claim 11, wherein the lower dielectric layer comprises at least two materials selected from PbO, SiO2, B2O3, Al2O3, and TiO2.

13. The plasma display panel of claim 11, wherein a portion in which the first alignment mark is formed has a thickness smaller than that of other portions in the lower dielectric layer.

14. The plasma display panel of claim 11, wherein the third electrode and the first alignment mark are made of the same material.

15. The plasma display panel of claim 11, wherein a second alignment mark corresponding to the first alignment mark is formed in the front substrate.
